(19) United States
(12) Patent Application Publication
(10) Pub. No.: US 2011/0062880 A1
(43) Pub. Date: Mar. 17, 2011

(54) BALANCE CIRCUIT AND INVERTER CIRCUIT COMPRISING THE SAME

(75) Inventors: Kwang Hee SUNG, Suwon-Si (KR); Mi Sun Kim, Seoul (KR); Jung Soo Kim, Seoul (KR)

(73) Assignee: Samsung Electro-Mechanics Co., Ltd., Suwon-Si (KR)

(21) Appl. No.: 12/615,926

(22) Filed: Nov. 10, 2009

(30) Foreign Application Priority Data
Sep. 17, 2009 (KR) 10-2009-0088062

(51) Int. Cl. H05B 41/36

(52) U.S. Cl. 315/255

(57) ABSTRACT

The present invention provides a balance circuit including: a first balance trans having a primary coil and a secondary coil, the primary coil being connected to an output terminal of a first lamp, and the secondary coil being connected to an output terminal of a second lamp and having a current controlled by the primary coil; and a second balance trans having a primary coil and a secondary coil, the primary coil being connected to an output terminal of a third lamp, and the secondary coil being connected to an output terminal of a fourth lamp and having a current controlled by the primary coil connected to the output terminal of the third lamp, wherein the secondary coil of the first balance trans is connected to the primary coil of the second balance trans, and an inverter circuit including the same.

### CROSS-REFERENCE TO RELATED APPLICATIONS

This application claims the benefit of Korean Patent Application No. 10-2009-0088062 filed with the Korea Intellectual Property Office on Sep. 17, 2009, the disclosure of which is incorporated herein by reference.

### BACKGROUND OF THE INVENTION

1. Field of the Invention

The present invention relates to a balance circuit and an inverter circuit comprising the same; and, more particularly, to a balance circuit for reducing a gap between output currents of lamps for a back light unit and an inverter circuit comprising the same.

2. Description of the Related Art

In general, a Liquid Crystal Display (LCD) is one of flat panel displays which display images through liquid crystal. Also, the LCD has characteristics of superior miniaturization to and lower consumed power than other displays, and has an advantage of a low driving voltage.

Since the LCD fails to emit light by itself, the LCD is required to be provided with a Back Light Unit (BLU). As for a light source of the BLU, a Cold Cathode Electrode Fluorescent Lamp (CCFL) or an External Electrode Fluorescent Lamp (EEFL) is being mostly used.

Turning-off of the cold cathode tube is made by applying an AC-voltage. Since the cold cathode tube does not depend on a filament-based preheating manner, the cold cathode tube is characterized by higher resistant to vibration, smaller diameter of a lamp, and longer lifetime of a lamp than a hot cathode tube.

Meanwhile, the cold cathode tube requires no filament-based preheating, so high voltage should be applied to the cold cathode tube. Further, in order to turn off the cold cathode tube, an inverter circuit for generating an AC high-voltage is necessary.

Also, each of light sources of the BLU in the LCD outputs currents different from one another due to their characteristic difference, which causes failure of uniform luminance of the LCD.

In order to keep luminance of the LCD uniform, the inverter circuit for driving the BLU of the LCD uses a balance coil to reduce a gap between currents outputted from each lamp.

In the prior art, an inverter circuit for driving a BLU of an LCD uses a balance coil which reduce a gap between output currents of a pair of lamps, thereby maintaining luminance uniformity of the whole LCD.

An LCD using the inverter circuit can reduce a gap between output currents of a pair of lamps adjacent to each other, but an LCD provided with four lamps fail to reduce a gap between output currents between adjacent lamps having no connection to a balance coil.

### SUMMARY OF THE INVENTION

The present invention has been proposed in order to overcome the above-described problems and it is, therefore, an object of the present invention to provide a balance circuit which forms a loop between a pair of lamps connected to each of balance transes and lamps adjacent to the pair of lamps through balance transes respectively connected to output terminals of lamps, thereby reducing a gap between output currents between balance transes adjacent to each other, and an inverter circuit comprising the same.

In accordance with one aspect of the present invention to achieve the object, there is provided a balance circuit including: a first balance trans having a primary coil and a secondary coil, the primary coil being connected to an output terminal of a first lamp, and the secondary coil being connected to an output terminal of a second lamp and having a current controlled by the primary coil; and a second balance trans having a primary coil and a secondary coil, the primary coil being connected to an output terminal of a third lamp, and the secondary coil being connected to an output terminal of a fourth lamp and having a current controlled by the primary coil connected to the output terminal of the third lamp, wherein the secondary coil of the first balance trans is connected to the primary coil of the second balance trans.

Also, it is preferable that a turn ratio of the first balance trans to the second balance trans is 1 to 1.

Also, it is preferable that the lamp corresponds to a Cold Cathode Electrode Fluorescent Lamp (CCFL).

Also, it is preferable that a current flowing to the secondary coil of the first balance trans has the same amount as a current flowing to the primary coil of the second balance trans.

In accordance with another aspect of the present invention to achieve the object, there is provided an inverter circuit including: a balance circuit; and a feedback controller, and wherein the balance circuit includes: a first balance trans having a primary coil whose one side is connected to an output terminal of a first lamp, and a secondary coil whose one side is connected to an output terminal of a second lamp and whose current is controlled by the primary coil; and a second balance trans having a primary coil whose one side is connected to an output terminal of a third lamp, and a secondary coil whose one side is connected to an output terminal of a fourth lamp and whose current is controlled by the primary coil connected to the output terminal of the third lamp, and wherein the feedback controller is connected to the other side of the primary coil of the first balance trans of the balance circuit and the other side of the secondary coil of the second balance trans, respectively and detects feedback signals to thereby control driving voltages of the lamps.

Also, it is preferable that a turn ratio of the first balance trans to the second balance trans is 1 to 1.

Also, it is preferable that the lamp corresponds to a Cold Cathode Electrode Fluorescent Lamp (CCFL).

Also, it is preferable that a current flowing to the secondary coil of the first balance trans has the same amount as a current flowing to the primary coil of the second balance trans.

Also, it is preferable that the feedback controller detects an output signal of the first lamp as a feedback signal from the other side of the primary coil of the first balance trans of the balance circuit, and detects an output signal of the fourth lamp as a feedback signal from the other side of the secondary coil of the second balance trans.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view showing a balance circuit in accordance with an embodiment of the present invention; and

FIG. 2 is a schematic view showing an inverter circuit in accordance with an embodiment of the present invention.

### DETAILED DESCRIPTION OF THE PREFERABLE EMBODIMENTS

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

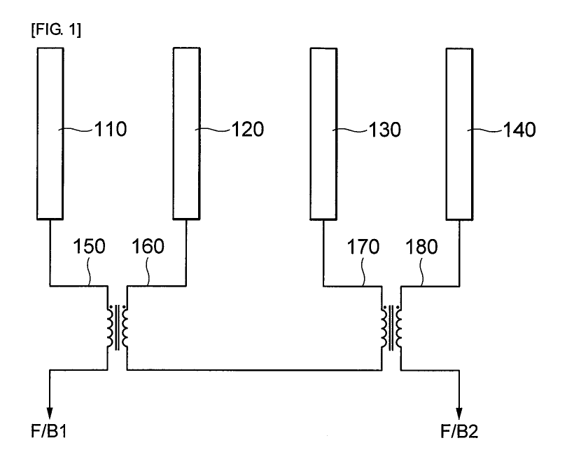

FIG. 1 is a schematic view showing a balance circuit in accordance with an embodiment of the present invention.

As shown in FIG. 1, the balance circuit in accordance with the embodiment of the present invention includes first to fourth lamps 110 to 140, and first and second balance trans.

First, the balance circuit in accordance with the embodiment of the present invention is a circuit which uses a balance trans so as to maintain a constant gap between currents outputted from output terminals of four lamps, thereby reducing a gap between the currents.

A primary coil 150 of the first balance trans has one side connected to an output terminal of a first lamp 110, and the other side connected to a feedback terminal F/B1, to thereby transmit an output current of the first lamp 110 as a feedback signal.

A secondary coil 160 of the first balance trans has one side connected to an output terminal of a second lamp 120, and a current flowing to the secondary coil 160 is controlled by a current of the primary coil 150. The other side of the secondary coil 160 of the first balance trans may be connected to a primary coil 170 of the second balance trans.

Also, the primary coil 170 of the second balance trans is connected to an output terminal of a third lamp 130, and is connected to the secondary coil 160 of the first balance trans. Therefore, a current of the secondary coil 160 of the first balance trans has the same amount as a current of the primary coil 170 of the second balance trans.

One side of a secondary coil 180 of the second balance trans is connected to an output terminal of a fourth lamp 140, and a current of the secondary coil 180 of the second balance trans may be controlled by a current of the primary coil 170 of the second balance trans.

The other side of the secondary coil 180 of the second balance trans is connected to the feedback terminal F/B2 to thereby transmit an output current of the fourth lamp 140 as a feedback signal.

Currents detected from output terminals of the first to fourth lamps 110 to 140 may have different amounts to one another. However, a current flowing to the secondary coil 160 of the first balance trans connected to the second lamp 120 may be controlled by a current of the primary coil 150 of the first balance trans connected to the first lamp 110.

Also, since a current of the primary coil 170 of the second balance trans connected to the third lamp has the same amount as a current of the secondary coil 160 of the first balance trans, a current of the secondary coil 180 of the second balance trans connected to the fourth lamp may be controlled by a current controlled by the current of the primary coil 150 of the first balance trans connected to the first lamp.

As a result, a first balance trans and a second balance trans can maintain a current balance so that the amounts of currents flowing to output terminals of the four lamps 110 to 140 become the same as one another.

For example, if it is assumed that currents detected from output terminals of first to fourth lamps 110 to 140 are 7.5 mA, 7.0 mA, 7.1 mA, and 6.5 mA, respectively, control of the current of each output terminal may be made at connecting to the balance circuit. In particular, a current (7.0 mA) of the secondary coil 160 of the first balance trans is controlled up to approximately 7.4˜7.5 mA by a current (7.5 mA) of the primary coil 150. Further, a current of the primary coil 170 of the second balance trans connected to the secondary coil 160 of the first balance trans is controlled to have the same amount as a current (approximately 7.4˜7.5 mA) of the secondary coil 160 of the first balance trans.

Also, a current of the secondary coil 180 of the second balance trans controlled by a current (approximately 7.4˜7.5 mA) of the primary coil 170 of the second balance trans is controlled to have a nearly identical amount to the current (approximately 7.4˜7.5 mA) of the primary coil 170 of the second balance trans.

Therefore, the balance circuit of the present invention can reduce a gap between currents outputted from the four lamps, i.e., from 0.4 mA (minimum) to 1 mA (maximum) to about 0.1˜0.2 mA.

It is preferable that the balance circuit of the present invention has a turn ratio of 1 to 1 with respect to the first balance trans to the second balance trans, in order to maintain constant amounts of currents flowing in the output terminals of the first lamp to fourth lamp 110 to 140.

In general, a CCFL may be used as a lamp, and each lamp may have an output terminal connected to a cold node of the CCFL lamp.

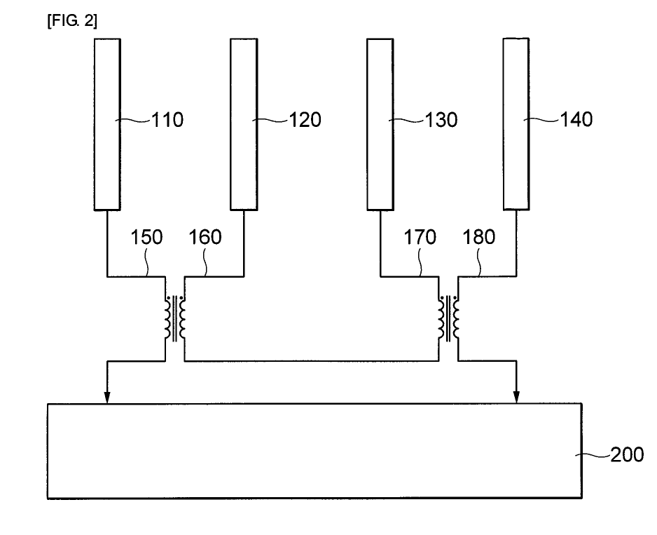

FIG. 2 is a schematic view showing an inverter circuit in accordance with an embodiment of the present invention.

As shown in FIG. 2, an inverter circuit in accordance with the embodiment of the present invention includes a balance circuit and a feedback controller.

As described above, the balance circuit includes a first balance trans having a primary coil 150 and a secondary coil 160. The primary coil has one side connected to an output terminal of a first lamp 110, and the secondary coil has one side connected to an output terminal of a second lamp 120 and has a current controlled by the primary coil 150.

The balance circuit may also include a second first balance trans having a primary coil 170 and a secondary coil 180. The primary coil 170 has one side connected to an output terminal of a third lamp 130 and the other side connected to the other side of the secondary coil 160 of the first balance trans, and the secondary coil 180 has one side connected to an output terminal of a fourth lamp 140 and has a current controlled by the primary coil 170 connected to the output terminal of the third lamp 130.

The feedback controller 200 is connected to the other side of the primary coil 150 of the first balance trans and the other side of the secondary coil 180 of the second balance trans, respectively, to detect a feedback signal to thereby control driving voltages of the lamps.

A turn ratio of the first balance trans to the second balance trans may be 1 to 1, and CCFLs may be used as lamps 110 to 140 of the inverter circuit.

In the inverter circuit of the present invention, the other side of the secondary coil 160 of the first balance trans is directly connected to the other side of the primary coil 170 of the second balance trans, so the amounts of currents flowing to the secondary coil 160 of the first balance trans and the primary coil 170 of the second balance trans may be the same as each other.

Also, the feedback controller 200 may detect an output signal of the first lamp 110 as a feedback signal from the other side of the primary coil 150 of the first balance trans, and detect an output signal of the fourth lamp as a feedback signal from the other side of the secondary coil 180 of the second balance trans.

The feedback controller 200 detects two feedback signals from the four lamps to thereby control driving voltages used for driving the four lamps.

In the inverter circuit of the present invention, it is possible to determine a current of the primary coil 150 of the first balance trans according to the output current of the first lamp 110 of the first balance trans, and to control a current of the secondary coil 160 of the first balance trans by a current of the primary coil 150 of the first balance trans.

Also, the current of the primary coil 170 of the second balance trans has the same amount as the current of the secondary coil 160 of the first balance trans, and the current of the secondary coil 180 of the second balance trans is controlled by the current of the primary coil 170 of the second balance trans.

Therefore, even though only signals of lower ends of the output terminals of the first lamp and fourth lamp are detected as feedback signals, it is possible to perform feedback-control at a level analogous to a case where feedback signals are detected from the output terminals of respective lamps.

In accordance with an embodiment of the present invention, it is possible to control currents flowing respective lamps in order to avoid a gap between currents outputted from four lamps, thereby maintaining luminance uniformity of an LCD.

In addition, it is possible to use 4-in 1 balance trans, and it is possible to simply configure a circuit by direct connection between respective balance trans coils.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A balance circuit comprising:
a first balance trans having a primary coil and a secondary coil, the primary coil being connected to an output terminal of a first lamp, and the secondary coil being connected to an output terminal of a second lamp and having a current controlled by the primary coil; and
a second balance trans having a primary coil and a secondary coil, the primary coil being connected to an output terminal of a third lamp, and the secondary coil being connected to an output terminal of a fourth lamp and having a current controlled by the primary coil connected to the output terminal of the third lamp,
wherein the secondary coil of the first balance trans is connected to the primary coil of the second balance trans.

2. The balance circuit of claim 1, wherein a turn ratio of the first balance trans to the second balance trans is 1 to 1.

3. The balance circuit of claim 1, wherein the lamp corresponds to a Cold Cathode Electrode Fluorescent Lamp (CCFL).

4. The balance circuit of claim 1, wherein a current flowing to the secondary coil of the first balance trans has the same amount as a current flowing to the primary coil of the second balance trans.

5. An inverter circuit comprising:
a balance circuit; and
a feedback controller, and
wherein the balance circuit comprises:
a first balance trans having a primary coil whose one side is connected to an output terminal of a first lamp, and a secondary coil whose one side is connected to an output terminal of a second lamp and whose current is controlled by the primary coil; and
a second balance trans having a primary coil whose one side is connected to an output terminal of a third lamp, and a secondary coil whose one side is connected to an output terminal of a fourth lamp and whose current is controlled by the primary coil connected to the output terminal of the third lamp, and
wherein the feedback controller is connected to the other side of the primary coil of the first balance trans of the balance circuit and the other side of the secondary coil of the second balance trans, respectively and detects feedback signals to thereby control driving voltages of the lamps.

6. The inverter circuit of claim 5, wherein a turn ratio of the first balance trans to the second balance trans is 1 to 1.

7. The inverter circuit of claim 5, wherein the lamp corresponds to a Cold Cathode Electrode Fluorescent Lamp (CCFL).

8. The inverter circuit of claim 5, wherein a current flowing to the secondary coil of the first balance trans has the same amount as a current flowing to the primary coil of the second balance trans.

9. The inverter circuit of claim 5, wherein the feedback controller detects an output signal of the first lamp as a feedback signal from the other side of the primary coil of the first balance trans of the balance circuit, and detects an output signal of the fourth lamp as a feedback signal from the other side of the secondary coil of the second balance trans.
